(19) United States
(12) Patent Application Publication
(10) Pub. No.: US 2014/0150568 A1
(43) Pub. Date: Jun. 5, 2014

(54) Portable Torque Verification System

(71) Applicant: Sterling L. Delbridge, Bancroft, ID (US)

(72) Inventor: Sterling L. Delbridge, Bancroft, ID (US)

(21) Appl. No.: 13/693,843

(22) Filed: Dec. 4, 2012

(51) Int. Cl. G01L 5/24

(52) U.S. Cl. CPC G01L 5/24
USPC 73/862.21

(57) ABSTRACT

A portable torque verification system for testing the accuracy of hydraulic, pneumatic, electrical, and manual torque wrenches. A first torque sensor is utilized for hydraulic, pneumatic, and electrical torque wrenches. A preferred second torque sensor measures the torque of manual torque wrenches. The second torque sensor is preferably supported by a support the height of which is preferably adjustable. Hydraulic connections to an external source of hydraulic fluid are provided so that the housing preferred for the components of the system may be closed for safety when an hydraulic wrench is tested. Electrical connections permit the use of an external torque meter. Within the housing the system additionally includes a reaction point, preferably removable and slidable, and a hydraulic pressure gauge. Also preferably, a rigid base plate is attached to the bottom of the housing and holds, inter alia, the first torque sensor, the support cylinder, and the reaction point.

### BACKGROUND OF THE INVENTION

1. Field of the Invention

This invention relates to a device for verifying the torque exerted by a manual torque wrench, an hydraulic torque wrench, a pneumatic torque wrench, or an electrical torque wrench; the device also preferably has the ability to verify the accuracy of the pressure gauge on a pump when such pump is utilized to supply hydraulic fluid to the device.

2. Description of the Related Art

Systems are known which verify the torque exerted by a manual wrench, but the inventor knows of none which are portable and can verify the torque provided by a manual torque wrench as well as an hydraulic torque wrench in relation to hydraulic pressure, a pneumatic torque wrench, or an electrical torque wrench.

Examples of patents for machines which verify the torque exerted for only a manual wrench are U.S. Pat. Nos. 2,691,295; 3,364,725; 3,456,485; 3,675,464; 3,979,942; 4,171,647; 4,517, 821; 4,759,225; 5,181,425; 5,703,277; 5,911,154; and 7,757,540.

### BRIEF SUMMARY OF THE INVENTION

The Portable Torque Verification System of the present invention preferably comprises a housing with one open or openable side, which is preferably the top. Also in one side of the housing are a connector for a first interior hydraulic hose and another connector for a second interior hydraulic hose to place such interior hydraulic hoses in fluid communication with external hydraulic hoses in fluid communication with a source of pressurized hydraulic fluid. A pressure gauge is also in fluid communication with the first interior hydraulic hose and its associated connector. As used herein, the term “pressure gauge” shall mean any device known in the art for measuring pressure, including, but not necessarily limited to, a device providing an analog readout or a sensor with a digital output.

Also inside the housing is located a first torque sensor, such as a torque transducer, for determining the torque exerted by an hydraulic torque wrench, a pneumatic torque wrench, or an electrical torque wrench. Additionally within the housing is a reaction plate against which the reaction arm of an hydraulic torque wrench, a pneumatic torque wrench, or an electrical torque wrench presses when such hydraulic torque wrench, pneumatic torque wrench, or electrical torque wrench is being tested. The reaction plate is preferably removable, preferably slidable, and preferably rotatable.

A second torque sensor, such as a torque transducer, for determining the torque exerted by a manual torque wrench, is also preferably placed, preferably vertically adjustably and even more preferably rotatably, within the housing. As this suggests, the position of the second torque sensor can optionally be vertically fixed.

Preferably, a rigid base plate, preferably a metal plate (and, even more preferably, an aluminium plate), is attached with vibrational insulators, preferably rubber legs, to the housing in order to isolate components on the rigid base plate from physical shocks.

On the rigid base plate are preferably mounted the first torque sensor, the second torque sensor, and either a reaction plate or a base for removably, preferably slidably, and preferably rotatably holding a reaction plate against which the reaction arm of an hydraulic torque wrench, a pneumatic torque wrench, or an electrical torque wrench presses when such hydraulic torque wrench, pneumatic torque wrench, or electrical torque wrench is being tested. The components on the rigid base plate can optionally be attached to the bottom of the housing, but then the shock protection does not exist.

Although not necessarily included as a component of the present invention, a torque meter is at least used in conjunction with such System. In either case, the torque meter is connected to and communicates with the torque sensors, preferably utilizing flexible electrical leads.

### BRIEF DESCRIPTION OF THE SEVERAL VIEWS OF THE DRAWING

FIG. 1 is a perspective view of the overall Portable Torque Verification System which, for purposes of illustration only, depicts the sides as though they were transparent.

FIG. 2 is a plan view from above the bottom of the housing illustrating a first channel and a second channel in the bottom of the housing

FIG. 3 is an elevational view of the rigid base plate holding a first torque sensor, a cylinder supporting a second torque sensor, and a slidable reaction plate.

FIG. 4 is an elevational view from the rear of the rigid base plate holding a first torque sensor, a cylinder supporting a second torque sensor, and a slidable reaction plate.

FIG. 5 is a plan view from above the rigid base plate holding a first torque sensor, a cylinder supporting a second torque sensor, and a slidable reaction plate.

FIG. 6 shows a pin and the reaction point having an aperture through which the pin can be placed to enter an aperture in the rigid base plate for maintaining the sliding reaction point at a given location.

FIG. 7 depicts a reaction point comprising a block having a projection on a side which is accommodated by a channel in a side of the mating block constituting the base.

FIG. 8 illustrates a reaction point comprising a block with a bottom having a C-channel to fit on top of the mating block constituting the base.

FIG. 9 portrays two tension screws within a mount for the cylinder which supports the second torque sensor.

FIG. 10 shows a worm gear located beneath the rigid base plate for rotating the cylinder which supports the second torque sensor.

FIG. 11 depicts a handle of a manual wrench between two pins extending from the top of the side of the housing that supports such handle when the manual wrench is attached to the second torque sensor.

FIG. 12 illustrates gear teeth on the cylinder that supports the second torque sensor.

FIG. 13 is an elevation view of a torque meter.

FIG. 14 is a plan view showing the bottom of a torque meter.

FIG. 15 is a view of the screen on the torque meter.

FIG. 16 shows anchors for a strap to restrain a torque wrench on the first torque sensor.

FIG. 17 portrays a reinforced transparent plastic cover.

### DETAILED DESCRIPTION OF THE INVENTION

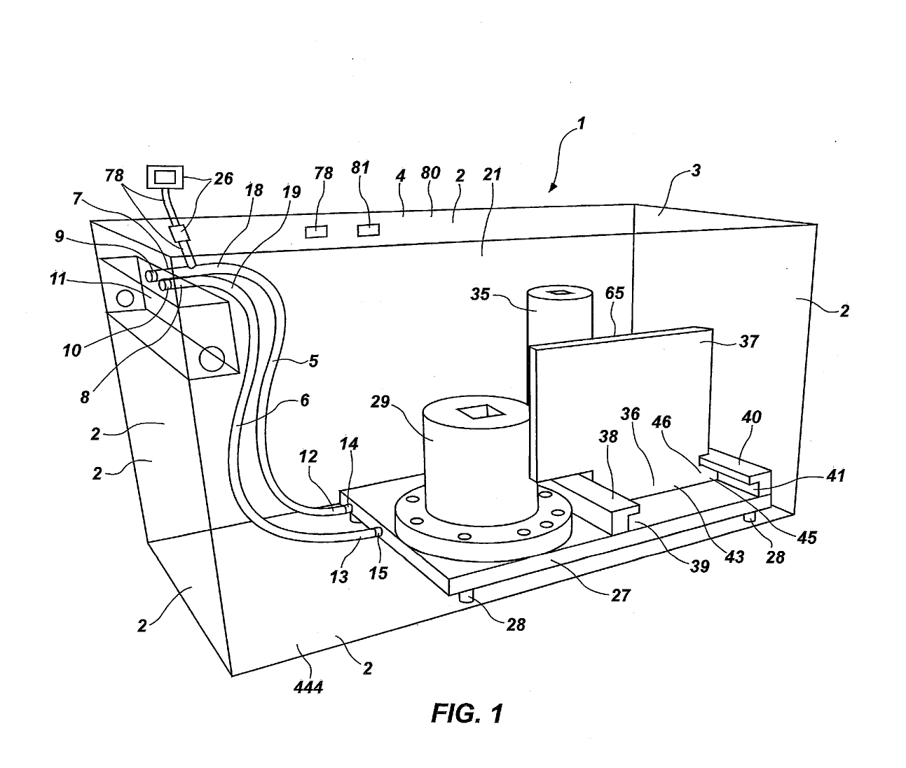

The present Portable Torque Verification System comprises, as illustrated in FIG. 1, preferably a housing 1, even more preferably a metal housing (and, even more preferably, a steel housing), for protection against damage caused by physical force. One side 2 of the housing 1, preferably, the top 3, is left uncovered or contains an aperture 4 of adequate size for accessing the components used for testing. As used herein, the term “open” shall mean either that a side 2 has no cover or contains an aperture 4 of adequate size for accessing the components used for testing.

Although used with the present invention but not necessarily a component of it, two hydraulic hoses 5, 6 (termed the “advance hose” and the “retract hose,” respectively) are utilized within the housing 1. Preferably the first end 7, 8 of each of the hydraulic hoses 5, 6 would be attached to connectors 9, 10 that would communicate with the exterior 11 of the housing 1 for connection to hydraulic hoses from an external source of hydraulic fluid; and the second end 12, 13 of each of the hydraulic hoses 5, 6 would have a connector 14, 15 for connecting directly to an hydraulic torque wrench intended to be tested.

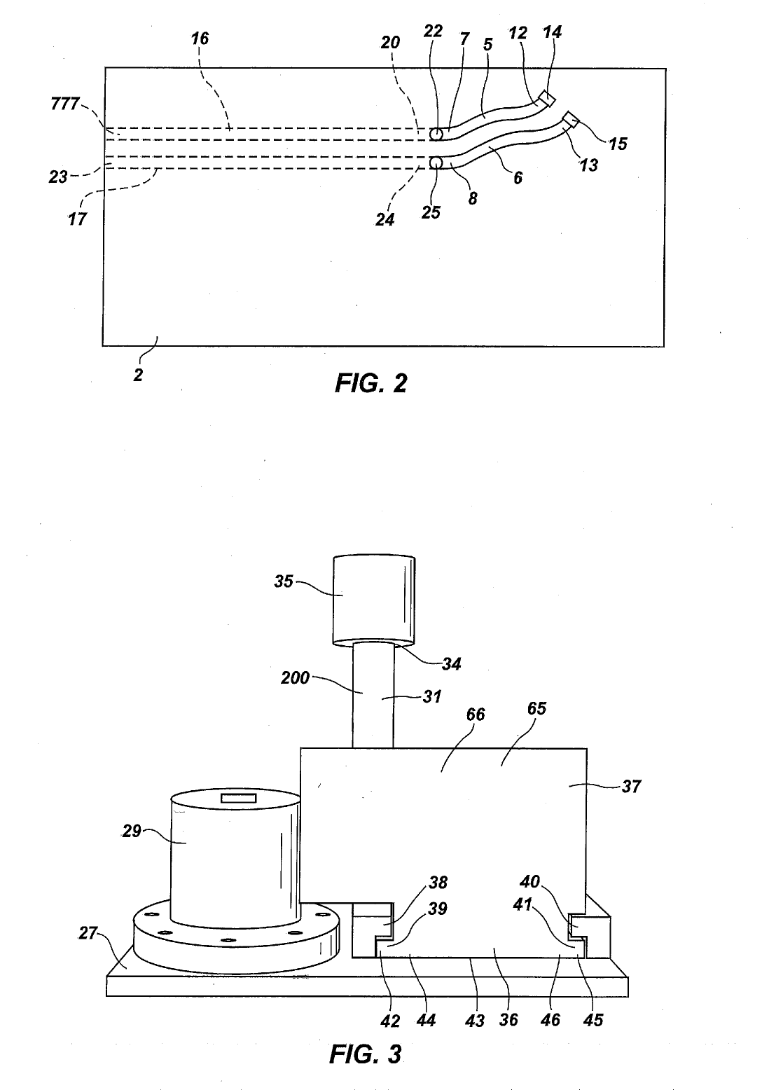

Optionally, as illustrated in FIG. 2, within one of the six sides 2 (including the top 3 and the bottom 4) of the housing 1 are contained two channels 16, 17. (Of course, any number of sides 2 could be used to create the housing 1—even just one side 2 if, for example, the housing 1 were desired to be a sphere or an oblate spheroid.) When employed, the two channels 16, 17 replace the first portions 18, 19 of the portions of the hydraulic hoses, 5, 6, which portions 18, 19 are, of course, attached to the first ends 7, 8 of the hydraulic hoses 5, 6. The first end of the first channel 16, termed the “advance channel,” communicates, through a side 2 of the housing 1, with the exterior 11 of the housing 1 and incorporates, at the exterior 11 of the housing 1, the connector 9 for the external hydraulic line; the second end 20 of the first channel 16 communicates with the interior 21 of the housing and incorporates a connector 22 for the first end 7 of the first flexible hydraulic line or hose 5, which, when the first channel 16 is utilized, is preferably, a hose whip, which has a connector 14 on its second end 12 (to connect with an hydraulic torque wrench intended to be tested). The first end 23 of the second channel 17, termed the “retract channel,” communicates, through a side 2 of the housing 1, with the exterior 11 of the housing 1 and incorporates, at the exterior 11 of the housing 1, the connector 10 for the external hydraulic line; the second end 24 of the second channel 17 communicates with the interior 21 of the housing 1 and incorporates a connector 25 for the first end 8 of the second flexible hydraulic line or hose 6, which, when the second channel 17 is utilized, is preferably, a hose whip, which has a connector 15 on its second end 13 (to connect with an hydraulic torque wrench intended to be tested). Preferably, the connector 14 on the second end 12 of the first flexible hydraulic line or hose 5 is a male connector; and the connector 15 on the second end 13 of the second flexible hydraulic line or hose 6 is a female connector, in order to assist in assuring the proper connecting of the first and second flexible hydraulic lines 5, 6 and, consequently, the proper flow of hydraulic fluid.

Communicating with the first hydraulic line or hose 5 or the first channel 16 is a gauge 26 for measuring the pressure of hydraulic fluid within the first hydraulic line or hose 5 or the first channel 16, when such hydraulic fluid is present in the first hydraulic line or hose 5 or the first channel 16. Such a gauge 26 is preferably a calibrated digital gauge, such as those available from Crystal Engineering Corporation of San Luis Obispo, Calif.

Preferably, a rigid base plate 27, preferably a metal plate (and, even more preferably, an aluminum plate), is attached with vibrational insulators 28, preferably rubber legs, to the housing 1 in order to isolate components on the rigid base plate 27 from physical shocks. In an embodiment with no housing 1 it is preferred not to have the vibrational insulators 28 or, indeed, any legs.

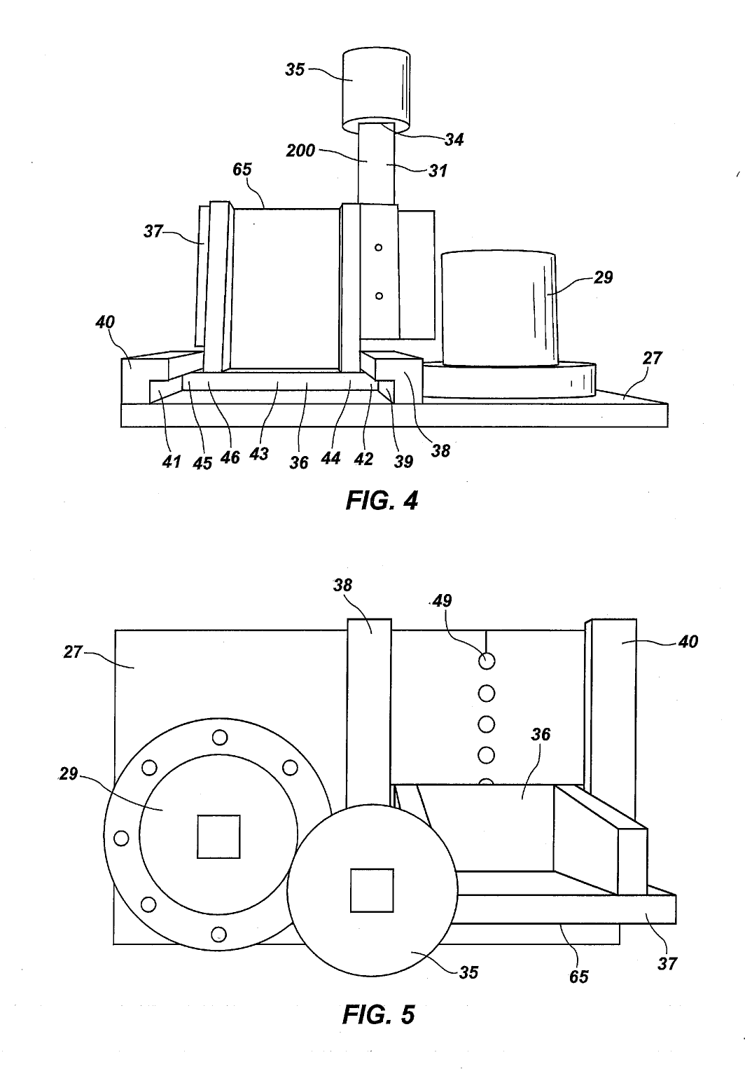

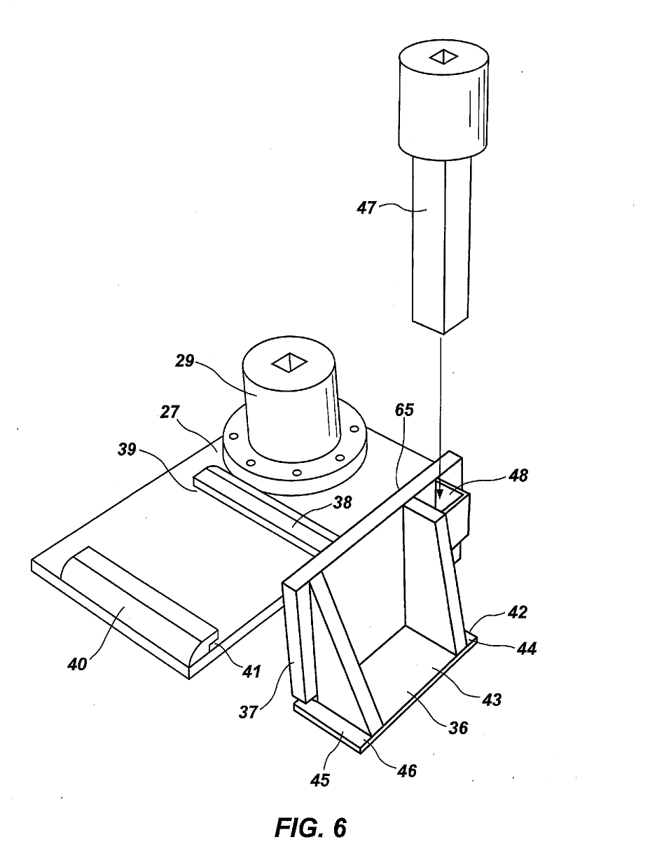

As depicted in FIGS. 3, 4, and 5, on the rigid base plate 27 are mounted a first torque sensor 29, such as a torque transducer, for determining the torque exerted by an hydraulic torque wrench, a pneumatic torque wrench, or an electrical torque wrench; preferably a support 200, which preferably utilizes any technology known in the art for having a lockably adjustable height, nonexclusive examples of which are (a) a lockably telescoping tube and (b) preferably a mount 30 for preferably slidably and lockably holding a column 31, preferably a cylinder (As defined herein “column” means a hollow or solid elongate member, and “cylinder” means a cylindrical object which can be either hollow or solid.), within a cavity 32 substantially perpendicular to the plane of the rigid base plate 27 and located over an aperture 33 in the rigid base plate 27 that accommodates the column 31 (although, in a less preferred option, the support 200 is attached, with or without a mount 30, at a fixed height to the rigid base plate 27), which support 200, as its name suggests, supports (at the top 34 of the support 200) a second torque sensor 35, such as a torque transducer, for determining the torque exerted by a manual torque wrench; and a base 36 (preferably a slidable base or a rotatable base or both a slideable and rotatable base) for holding, preferably removably holding, a reaction point 37 against which the reaction arm of an hydraulic torque wrench, a pneumatic torque wrench, or an electrical torque wrench presses when such hydraulic torque wrench, pneumatic torque wrench, or electrical torque wrench is being tested. (Any technology known in the art can be employed to make the base 36 slidable or rotatable; but, for creating slidability it is preferred to have a first L-shaped rail 38 creating a C-channel 39 in conjunction with the rigid base plate 27, a second L-shaped rail 40 creating an opposed C-channel 41 in conjunction with the rigid base plate 27, a first projection 42 near the bottom 43 of the base 36 on a first side 44 of the base 36 to slide within the C-channel 39, and a second projection 45 near the bottom 43 of the base 36 on a second side 46 of the base 36 to slide within the opposed C-channel 41. The base 36 can be held in a desired position on the rigid base plate 27 using any technology known in the art but, preferably, as illustrated in FIG. 6, a pin 47 slides into an aperture 48 in the base 36 and into the desired one of a series of apertures 49 in the rigid base plate 27.) Optionally, two or more anchors 102 are attached, directly or indirectly, to the rigid base plate 27 near the first torque sensor 29, as illustrated in FIG. 16, in order to accommodate a strap, preferably, a nylon strap, to restrain an hydraulic torque wrench or, optionally, a pneumatic torque wrench or an electrical torque wrench. The components on the rigid base plate 27 can optionally be attached to the bottom 4 of the housing 1, but then the shock protection does not exist. And as indicated above the housing 1 is preferred but is not essential. The second torque sensor 35 is also preferred, but not essential. When there is a second torque sensor 35 but no support 200, the second transducer may either be directly attached to the rigid base plate 27 or indirectly connected to the rigid base plate 27 with a mount 230.

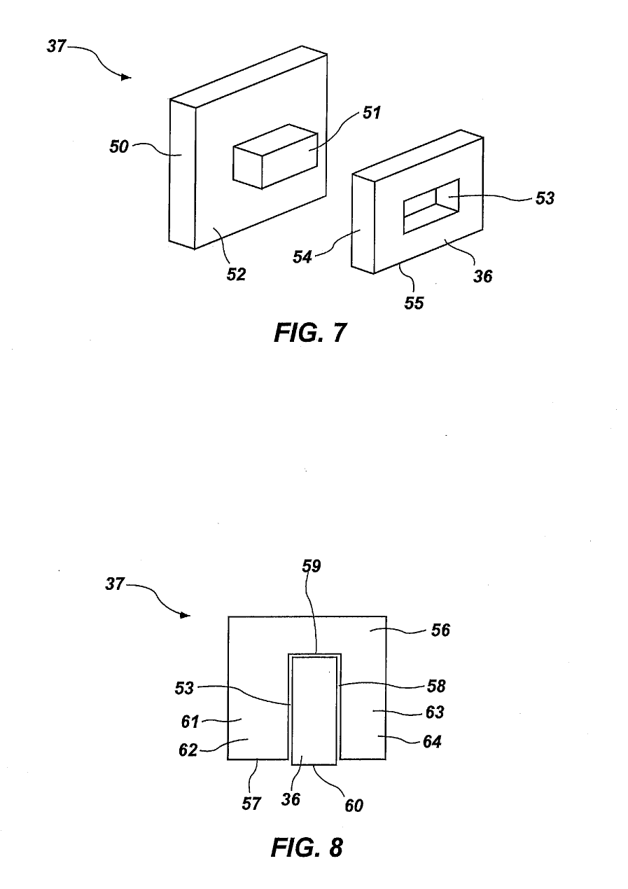

Two examples of a removable reaction point 37 are (1) a block 50, as shown in FIG. 7, having a projection 51 on a side 52 that is accommodated by a channel 53 in a side 54 of the mating block 55 constituting the base 36, which is attached to the rigid base plate 27 (or the bottom 4 of the housing 1 in an embodiment having no rigid base plate 27) and (2) a reaction point 37, as depicted in FIG. 8, comprising a block 56 with a bottom 57 having a C-channel 58 to fit on the top 59 of the mating block 60 constituting the base 36, with the thickness of the portion 61 of the block 56 on the side 62 of the block 56 intended to be contacted by a reaction arm of an hydraulic torque wrench, a pneumatic torque wrench, or an electrical torque wrench preferably being thicker than the portion 63 of the block 56 of the reaction point 37 on the side 64 of the block 56 opposite to the side 62 of the block 56 intended to be contacted by a reaction arm of an hydraulic torque wrench, a pneumatic torque wrench, or an electrical torque wrench, and most preferably being twice as thick as the portion 63 of the block 56 of the reaction point 37 on the side 64 of the block 56 opposite to the side 62 of the block 56 intended to be contacted by a reaction arm of an hydraulic torque wrench, a pneumatic torque wrench, or an electrical torque wrench.

The size, including thickness, and shape of each reaction point 37 is selected (1) to maximize the surface area of the reaction arm that contacts the reaction point 37 (Preferably, at least three fourths of the length of the reaction arm should contact the reaction point 37.) and (2) to allow the reaction arm to push uniformly against the portion 65 of the face 66 of the reaction point 37 which the reaction arm contacts. Generally, the face 66 of the reaction point 37 is planar; optionally, however, it can be curved to conform to the exterior surface of the torque wrench which is to be tested.

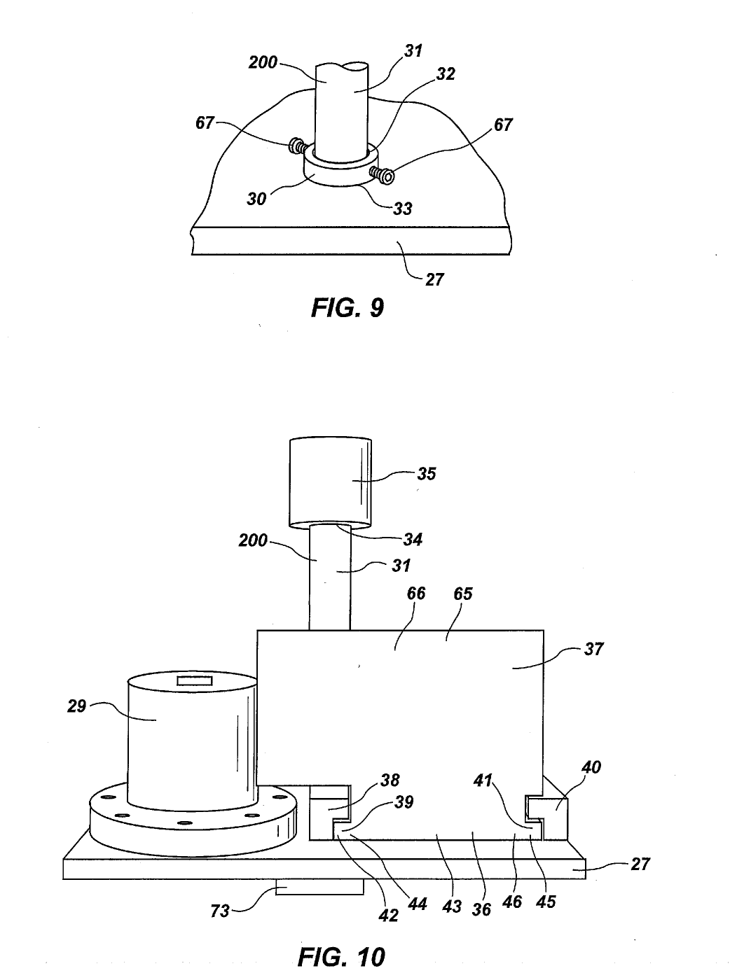

In order to lock the cylinder 31 in a desired position within the cavity 32 of the mount 30, preferably one or more (and, most preferably, two) tension screws 67 threadably located within the mount 30 are, as portrayed in FIG. 9, screwed against the cylinder 31. (Of course, any other locking means known in the art could optionally be utilized.)

The support 200 is raised to such an elevation (and locked into position at such elevation) that a manual torque wrench 68 removably attached to the second torque sensor 35 will have the handle 69 of such manual torque wrench 68 supported by the top 70 of a side 2 of the housing 1 in order to avoid side loading the manual torque wrench 68. An hydraulic torque wrench, a pneumatic torque wrench, or an electrical torque wrench is supported by the first torque sensor 29 (used to measure the torque exerted by the hydraulic torque wrench, a pneumatic torque wrench, or an electrical torque wrench), itself. Preferably, a wear sleeve 71 (and, even more preferably, a TEFLON wear sleeve) caps the first torque sensor 29 but has an aperture 72 situated so as to provide access to the first torque sensor 29 by the hydraulic torque wrench, pneumatic torque wrench, or electrical torque wrench. In an embodiment having no housing 1 but having a second torque sensor 35 and a support 200, an auxiliary support 201 which has either a fixed or lockably variable height just as does the support 200 and which is attached to the rigid base plate 27 is preferably available to support the handle 69 of a manual torque wrench 68.

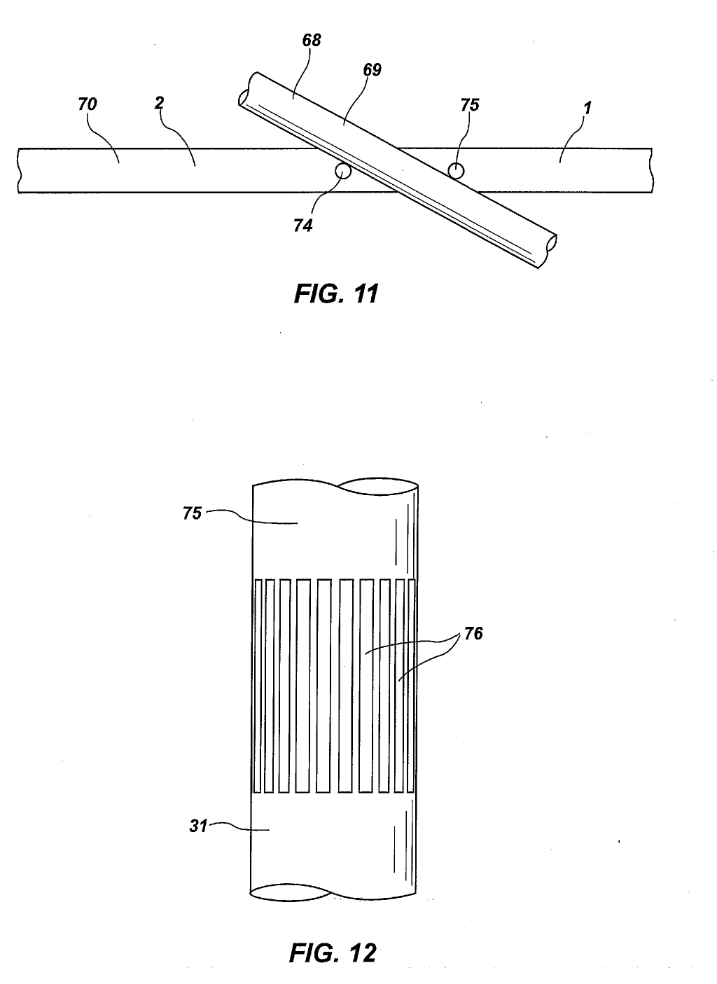

As its name suggests, the manual torque wrench 68 is normally turned by a human operator, preferably maintaining the handle 69 of the manual wrench on the top 70 of a side 2 of the housing 1. Optionally, however, when the support 200 is a cylinder, any means known in the art for rotating a cylinder, preferably a worm gear 73 and preferably located below the rigid base plate 27 as depicted in FIG. 10, would turn the cylinder 31 supporting the second torque sensor 35 and thereby turn the second torque sensor 35 while the handle 69 of the manual torque wrench 68 is prevented from moving by a first projection 74, preferably a pin, extending from the top 70 of the side 2 of the housing 1 that supports such handle 69, which would be near (and during the turning, adjacent) to the handle 69 of the manual torque wrench 68 while a second projection 75, preferably a pin, extending from the side 2 would be on the opposite side of the handle 69 of the manual torque wrench 68 in order to stabilize the handle 69 on the top 70 of the side 2 of the housing 1, as illustrated in FIG. 11. In an embodiment having no housing 1, such first projection 74 and such second projection 75 are preferably located on the top 202 of the auxiliary support 201 when such auxiliary support 201 is utilized; and in an embodiment having a second torque sensor 35 but no support 200, such first projection 74 and such second projection 75 are preferably present, on the rigid base plate 27. When the support 200 is other than a cylinder (or, even optionally, when the support 200 is a cylinder, the mount 30 is optionally any rotatable mount known in the art. Thus, the support 200 can optionally be rotated either directly, in the case when the column 31 is a cylinder, or indirectly, in the case when the support 200 is other than a cylinder or, optionally, a cylinder. As used herein, the term “rotatable support” shall mean and include both a support 200 rotatated directly (e.g., by gears or friction in conjunction with a motor) and a support 200 rotated by a rotatable mount. And when there is a second torque sensor 35 but no support 200, the second transducer is preferably indirectly attached to the rigid base plate 27 with a mount 230 which mount is any rotatable mount known in the art.

In the version with a rotating column 31, four further options exist. In the first option, the System would include removable columns 31 of various lengths for having the second torque sensor 35 at the desired height above the rigid base plate 27. For the second option, the distance from the rigid base plate 27 at which the column 31 is attached could, using any structure known in the art, be manually adjusted. With the third option, such distance would, using any motorized device known in the art, be remotely (e.g., electrically) adjusted. And the fourth option applies only when a cylinder 31 us utilized: the workable area of contact between the rotating means and the surface 75 of the cylinder 31 would be extended (for example, by having the length of gear teeth 76 on the cylinder 31 increased, as portrayed in FIG. 12) so that the cylinder 31 could be raised and lowered while still having the workable area of contact in a proper position for the rotating means to turn the cylinder 31. For the first three options, a separate means for locking the cylinder would not be necessary. And in the case of the fourth option a separate locking means would only be necessary if there is insufficient frictional contact between the cylinder and the rotating means. If a separate locking means is either necessary or desirable, any rotatable mount known in the art, such as a bearings and bearing races, having locking (tension) screws (or other locking means) attached to it could be located adjacent to the aperture in the rigid base plate 27.

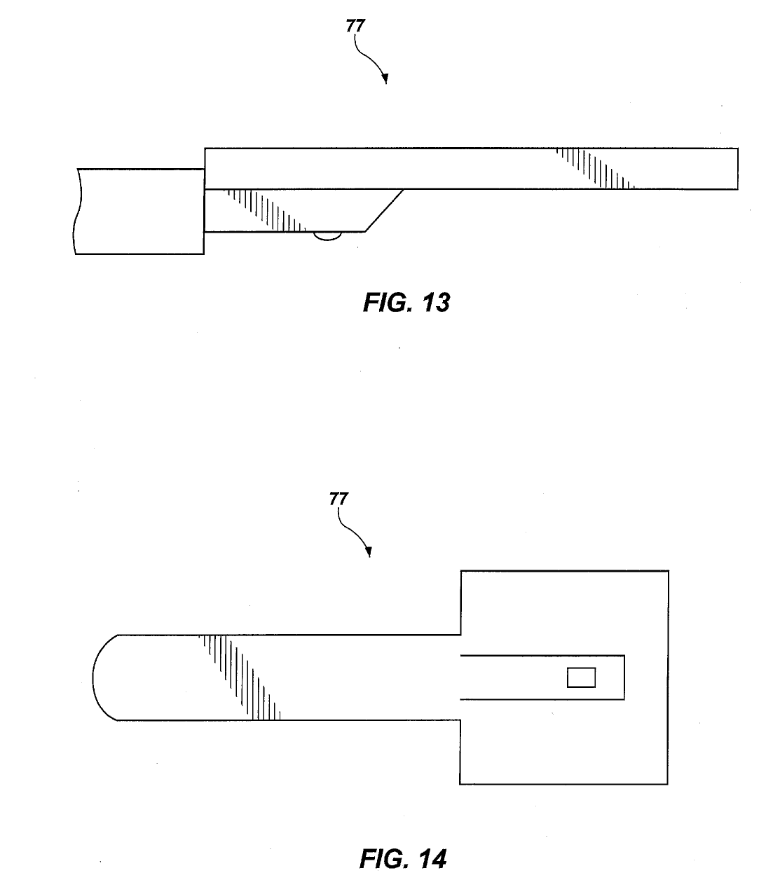

Although not necessarily included as a component of the Portable Torque Verification System, a torque meter 77, which is illustrated in FIGS. 13, 14, and 15, is at least used in conjunction with such System. In either case, the torque meter 77 is connected to and communicates with the first torque sensor 29 and the second torque sensor 35, preferably utilizing flexible electrical leads that are well known in the art. Preferably, the torque meter 77 has the ability to display its measurement in either foot-pounds or newton-meters.

Similarly, the pressure gauge 26 preferably is attached to and communicates with the first hydraulic line or hose 5 or the first channel 16 through an hydraulic hose 78. Optionally, when the output from the pressure gauge 26 is digital, a single display can show both pressure and torque.

Preferably, a holder 79, preferably a magnetic holder, is, as shown in FIG. 1, located on an interior side 80 of the housing 1 in order to retain the pressure gauge 26; and, optionally, another holder 81, preferably a magnetic holder, is located on an interior side of the housing for the torque meter 77.

For testing of a pneumatic torque wrench, an electrical torque wrench, and a manual torque wrench, a side 2, preferably the top 3, of the housing 1 is, as noted above preferably left open or contains an aperture 4 of adequate size for accessing the component used for testing. This can also be done for an hydraulic torque wrench; but, for safety, a cover 79 is preferably removably, and even more preferably, lockably, attached to the housing 1 in order to close the open side 2 of the housing 1. Similarly, an embodiment without the housing 1 can be used to test all four types of torque wrenches, although because of safety concerns this would be less preferred for an hydraulic torque wrench.

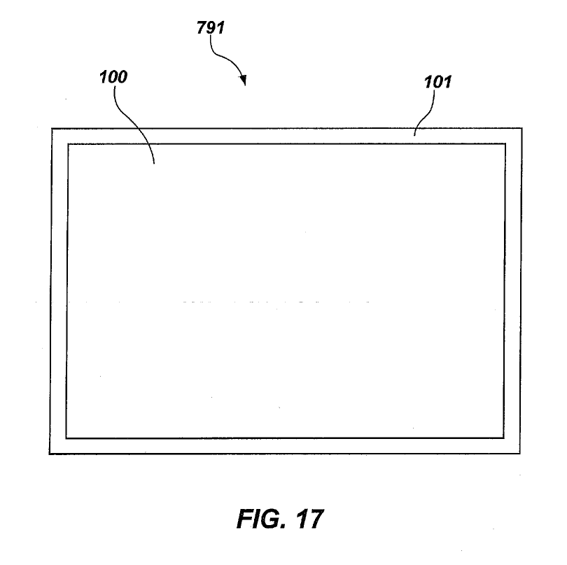

With the cover 79 in place, if either the pressure gauge 26 and the torque meter 77 is inside the housing 1, the cover 79 must be transparent. Preferably, the cover 79 in such a situation is a transparent plastic, most preferably, LEXAN produced by SABIC Innovative Plastics of Pittsfield, Mass. An additional preference is to reinforce the transparent plastic, e.g., by placing such plastic 100 in a steel frame 101, as illustrated in FIG. 17.

Optionally, the cover 79 is not transparent; and the pressure gauge 26, as well as the torque meter 77, is remote from the housing 1. (In fact, this is preferred for the torque meter 77.) In such a situation, the housing 1 may have one or more small apertures 82 to accommodate the flexible electrical leads and the hydraulic hoses 5, 6. Preferably, however, electrical leads communicating with the first torque sensor 29 and, optionally, the second torque sensor 35 each have a first end connected to the torque sensor 29, 35 and a second end communicating, through a side 2 of the housing 1, with the exterior 11 of the housing 1, by having the second end of each electrical lead being attached to a connector that is well known in the art, at the exterior 11 of the housing 1 and communicating with the exterior 11 of the housing 1, for an electrical lead from the torque meter, as depicted in FIG. 13. Also preferably, the hydraulic hose 78 intended for use by the pressure gauge 26 in communicating with the first hydraulic line or hose 5 or the first channel 16 comprises two portions—a first portion has a first end attached to and communicating with the first hydraulic line or hose 5 or the first channel 16 and has a second end communicating, through a side 2 of the housing 1, with the exterior 11 of the housing 1, with the second end of the first portion of the hydraulic hose 78 being attached to a connector known in the art, at the exterior 11 of the housing 1, for accommodating a mating connector known in the art and attached to the first end of the second portion of the hydraulic hose 78, which second portion is attached to and communicates with the pressure gauge 26.

Also optionally, any portable cart known in the art with a drawer for accessories is employed to hold and move the housing 1 and other components of the System.

In operation, the desired setting on the torque wrench is selected; the torque wrench is connected to the appropriate torque sensor 29, 35; and the torque meter 77 shows the actual torque that is achieved by the torque wrench. If the torque wrench does not meet the torque specification range, the torque wrench is determined to be defective and, presumably, sent by its owner for repairs.

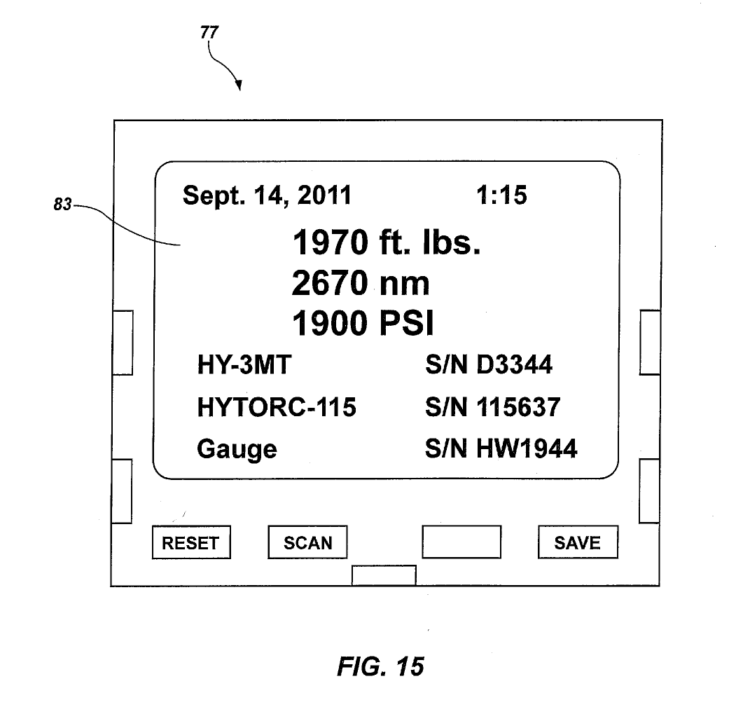

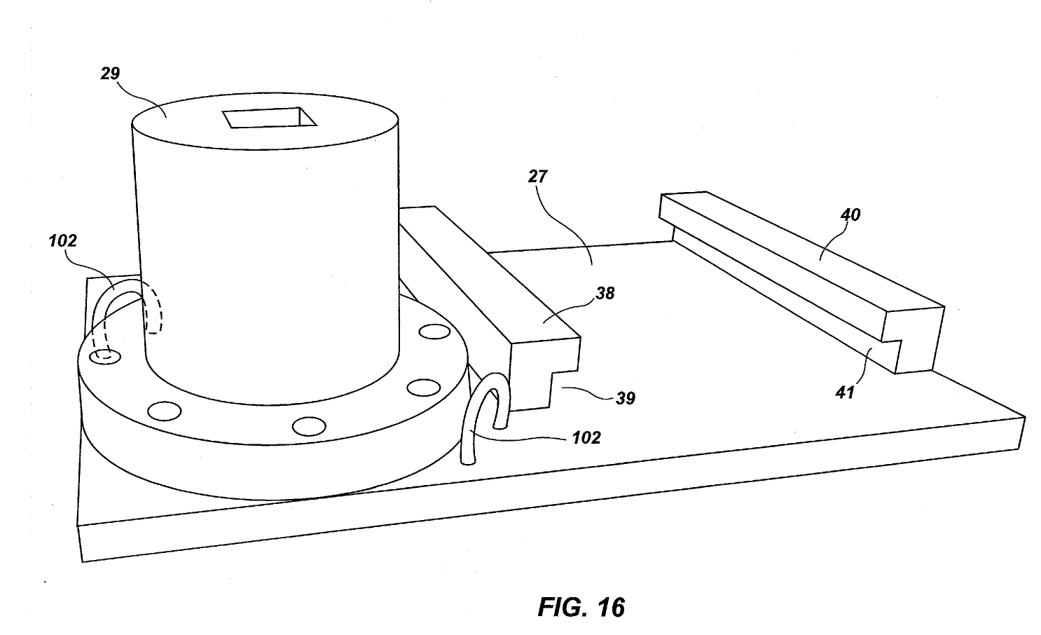

FIG. 15 shows the screen 83 of the torque meter 77 with available information and input ports. Using any technology known in the art, the torque meter 77 preferably can store and display torque as well as pressure and serial numbers of wrenches and sources of pressure. Using technology known in the art the torque meter 77 can connect to a bar code reader known in the art to obtain bar codes identifying serial numbers of wrenches and sources of pressure. Again utilizing technology known in the art, the torque meter 77 can record this information and even transfer a copy of such information to a portable storage medium, for example, a micro chip that can be employed to record and retain the test history for a torque wrench.

Where, electrical leads are utilized, one of ordinary skill in the art will understand that such leads can be replaced with electrical transmitters and receivers, such as BLUETOOTH technology.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A portable torque verification system, which comprises:
a housing having an open side and a bottom;
a first torque sensor mounted to the bottom of said housing;
a support having a lockably adjustable height mounted to the bottom of said housing;
a second torque sensor supported by said support; and
a reaction point attached to the bottom of said housing.

2. The portable torque verification system as recited in claim 1, further comprising:
a rigid base plate attached to the bottom of said housing with vibrational insulators and being located between the bottom of said housing and said first torque sensor, said support, and said reaction point so that said first torque sensor, said support, and said reaction point are attached to said rigid base plate and thereby attached to the bottom of said housing.

3. The portable torque verification system as recited in claim 2, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

4. The portable torque verification system as recited in claim 3, wherein:
said reaction point is removable.

5. The portable torque verification system as recited in claim 4, wherein:
said reaction point is slidable.

6. The portable torque verification system as recited in claim 5, further comprising:
a means for rotating said support.

7. The portable torque verification system as recited in claim 4, further comprising:
a means for rotating said support.

8. The portable torque verification system as recited in claim 3, wherein:
said reaction point is slidable.

9. The portable torque verification system as recited in claim 8, further comprising:
a means for rotating said support.

10. The portable torque verification system as recited in claim 3, further comprising:
a means for rotating said support.

11. The portable torque verification system as recited in claim 2, wherein:
said reaction point is removable.

12. The portable torque verification system as recited in claim 11, wherein:
said reaction point is slidable.

13. The portable torque verification system as recited in claim 12, further comprising:
a means for rotating said support.

14. The portable torque verification system as recited in claim 11, further comprising:
a means for rotating said support.

15. The portable torque verification system as recited in claim 2, wherein:
said reaction point is slidable.

16. The portable torque verification system as recited in claim 15, further comprising:
a means for rotating said support.

17. The portable torque verification system as recited in claim 2, further comprising:
a means for rotating said support.

18. The portable torque verification system as recited in claim 1, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

19. The portable torque verification system as recited in claim 18, wherein:
said reaction point is removable.

20. The portable torque verification system as recited in claim 19, wherein:
said reaction point is slidable.

21. The portable torque verification system as recited in claim 20, further comprising:
a means for rotating said support.

22. The portable torque verification system as recited in claim 19, further comprising:
a means for rotating said support.

23. The portable torque verification system as recited in claim 18, wherein:
said reaction point is slidable.

24. The portable torque verification system as recited in claim 23, further comprising:
a means for rotating said support.

25. The portable torque verification system as recited in claim 18, further comprising:
a means for rotating said support.

26. The portable torque verification system as recited in claim 1, wherein:
said reaction point is removable.

27. The portable torque verification system as recited in claim 26, wherein:
said reaction point is slidable.

28. The portable torque verification system as recited in claim 27, further comprising:
a means for rotating said support.

29. The portable torque verification system as recited in claim 26, further comprising:
a means for rotating said support.

30. The portable torque verification system as recited in claim 1, wherein:
said reaction point is slidable.

31. The portable torque verification system as recited in claim 30, further comprising:
a means for rotating said support.

32. The portable torque verification system as recited in claim 1, further comprising:
a means for rotating said support.

33. A portable torque verification system, which comprises:
a housing having an open side and a bottom;
a rigid base plate attached to the bottom of said housing with vibrational insulators;
a first torque sensor attached to said rigid base plate;
a support having a lockably adjustable height and mounted to said rigid base plate;
a second torque sensor supported by said support; and
a removable, slidable reaction point attached to said rigid base plate.

34. A portable torque verification system, which comprises:
a housing having an open side and a bottom;
a rigid base plate attached to the bottom of said housing with vibrational insulators;
a first torque sensor attached to said rigid base plate;
a support having a lockably adjustable height and mounted to said rigid base plate;
a means for rotating said support;
a second torque sensor supported by said support; and
a removable, slidable reaction point attached to said rigid base plate.

35. A portable torque verification system, which comprises:
a housing having an open side and a bottom;
a first torque sensor mounted to the bottom of said housing;
a support vertically fixedly mounted to the bottom of said housing;
a second torque sensor supported by said support; and
a reaction point attached to the bottom of said housing.

36. The portable torque verification system as recited in claim 35, further comprising:
a rigid base plate attached to the bottom of said housing with vibrational insulators and being located between the bottom of said housing and said first torque sensor, said support, and said reaction point so that said first torque sensor, said support, and said reaction point are attached to said rigid base plate and thereby attached to the bottom of said housing.

37. The portable torque verification system as recited in claim 36, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

38. The portable torque verification system as recited in claim 37, wherein:
said reaction point is removable.

39. The portable torque verification system as recited in claim 38, wherein:
said reaction point is slidable.

40. The portable torque verification system as recited in claim 39, further comprising:
a means for rotating said support.

41. The portable torque verification system as recited in claim 38, further comprising:
a means for rotating said support.

42. The portable torque verification system as recited in claim 37, wherein:
said reaction point is slidable.

43. The portable torque verification system as recited in claim 42, further comprising:
a means for rotating said support.

44. The portable torque verification system as recited in claim 37, further comprising:
a means for rotating said support.

45. The portable torque verification system as recited in claim 36, wherein:
said reaction point is removable.

46. The portable torque verification system as recited in claim 45, wherein:
said reaction point is slidable.

47. The portable torque verification system as recited in claim 46, further comprising:
a means for rotating said support.

48. The portable torque verification system as recited in claim 45, further comprising:
a means for rotating said support.

49. The portable torque verification system as recited in claim 36, wherein:
said reaction point is slidable.

50. The portable torque verification system as recited in claim 49, further comprising:
a means for rotating said support.

51. The portable torque verification system as recited in claim 36, further comprising:
a means for rotating said support.

52. The portable torque verification system as recited in claim 35, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

53. The portable torque verification system as recited in claim 52, wherein:
said reaction point is removable.

54. The portable torque verification system as recited in claim 53, wherein:
said reaction point is slidable.

55. The portable torque verification system as recited in claim 54, further comprising:
a means for rotating said support.

56. The portable torque verification system as recited in claim 53, further comprising:
a means for rotating said support.

57. The portable torque verification system as recited in claim 52, wherein:
said reaction point is slidable.

58. The portable torque verification system as recited in claim 57, further comprising:
a means for rotating said support.

59. The portable torque verification system as recited in claim 52, further comprising:
a means for rotating said support.

60. The portable torque verification system as recited in claim 35, wherein:
said reaction point is removable.

61. The portable torque verification system as recited in claim 60, wherein:
said reaction point is slidable.

62. The portable torque verification system as recited in claim 61, further comprising:
a means for rotating said support.

63. The portable torque verification system as recited in claim 60, further comprising:
a means for rotating said support.

64. The portable torque verification system as recited in claim 35, wherein:
said reaction point is slidable.

65. The portable torque verification system as recited in claim 64, further comprising:
a means for rotating said support.

66. The portable torque verification system as recited in claim 35, further comprising:
a means for rotating said support.

67. A portable torque verification system, which comprises:
a housing having an open side and a bottom;
a rigid base plate attached to the bottom of said housing with vibrational insulators;
a first torque sensor attached to said rigid base plate;
a support vertically fixedly mounted to said rigid base plate;
a second torque sensor supported by said support; and
a removable, slidable reaction point attached to said rigid base plate.

68. A portable torque verification system, which comprises:
a housing having an open side and a bottom;
a rigid base plate attached to the bottom of said housing with vibrational insulators;
a first torque sensor attached to said rigid base plate;
a support vertically fixedly mounted to said rigid base plate;
a means for rotating said support;
a second torque sensor supported by said support; and
a removable, slidable reaction point attached to said rigid base plate.

69. A portable torque verification system, which comprises:
a housing having an open side and a bottom;
a first torque sensor on the bottom of said housing; and
a reaction point attached to the bottom of said housing.

70. The portable torque verification system as recited in claim 69, further comprising:
a rigid base plate attached to the bottom of said housing with vibrational insulators and being located between the bottom of said housing and said first torque sensor and the reaction point so that said first torque sensor and the reaction point are attached to said rigid base plate and thereby attached to the bottom of said housing.

71. The portable torque verification system as recited in claim 70, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

72. The portable torque verification system as recited in claim 71, wherein:
said reaction point is removable.

73. The portable torque verification system as recited in claim 72, wherein:
said reaction point is slidable.

74. The portable torque verification system as recited in claim 71, wherein:
said reaction point is slidable.

75. The portable torque verification system as recited in claim 70, wherein:
said reaction point is removable.

76. The portable torque verification system as recited in claim 75, wherein:
said reaction point is slidable.

77. The portable torque verification system as recited in claim 70, wherein:
said reaction point is slidable.

78. The portable torque verification system as recited in claim 69, further comprising:
a cover for the open side removably attached to said housing to close the open side of said housing;
a first hydraulic connector in a side of said housing communicating with the exterior of said housing;
a second hydraulic connector in a side of said housing communication with the exterior of said housing;
a first hydraulic hose having a first end attached to said first hydraulic connector and a second end having a connector for connecting to an hydraulic torque wrench;
a second hydraulic hose having a first end attached to said second hydraulic connector and a second end having a connector for connecting to an hydraulic torque wrench;
an electrical connector in a side of said housing communicating with the exterior of said housing and being adapted for receiving at least one electrical lead from a torque meter; and
at least one electrical lead communicating with said first torque sensor through a first end of each said electrical lead being attached to said first torque sensor and communicating with said electrical connector by having a second end of each said electrical lead attached to said electrical connector.

79. The portable torque verification system as recited in claim 78, wherein:
said reaction point is removable.

80. The portable torque verification system as recited in claim 79, wherein:
said reaction point is slidable.

81. The portable torque verification system as recited in claim 78, wherein:
said reaction point is slidable.

82. The portable torque verification system as recited in claim 69, wherein:
said reaction point is removable.

83. The portable torque verification system as recited in claim 82, wherein:
said reaction point is slidable.

84. The portable torque verification system as recited in claim 69, wherein:
said reaction point is slidable.

85. A portable torque verification system, which comprises:
a rigid base plate;
a first torque sensor attached to said rigid base plate;
a second torque sensor attached to said rigid base plate; and
a reaction point attached to said rigid base plate.

86. The portable torque verification system as recited in claim 85, wherein:
said reaction point is removable.

87. The portable torque verification system as recited in claim 86, wherein:
said reaction point is slidable.

88. The portable torque verification system as recited in claim 87, further comprising:
a means for rotating said second transducer.

89. The portable torque verification system as recited in claim 86, further comprising:
a means for rotating said second transducer.

90. The portable torque verification system as recited in claim 85, wherein:
said reaction point is slidable.

91. The portable torque verification system as recited in claim 90, further comprising:
a means for rotating said second transducer.

92. The portable torque verification system as recited in claim 85, further comprising:
a means for rotating said second transducer.

93. The portable torque verification system as recited in claim 85, further comprising:
an auxiliary support attached to said rigid base plate, said auxiliary support having a fixed height.

94. The portable torque verification system as recited in claim 93, wherein:
said reaction point is removable.

95. The portable torque verification system as recited in claim 94, wherein:
said reaction point is slidable.

96. The portable torque verification system as recited in claim 95, further comprising:
a means for rotating said second transducer.

97. The portable torque verification system as recited in claim 94, further comprising:
a means for rotating said second transducer.

98. The portable torque verification system as recited in claim 93, wherein:
said reaction point is slidable.

99. The portable torque verification system as recited in claim 98, further comprising:
a means for rotating said second transducer.

100. The portable torque verification system as recited in claim 93, further comprising:
a means for rotating said second transducer.

101. The portable torque verification system as recited in claim 85, further comprising:
an auxiliary support attached to said rigid base plate, said auxiliary support having a lockably variable height.

102. The portable torque verification system as recited in claim 101, wherein:
said reaction point is removable.

103. The portable torque verification system as recited in claim 102, wherein:
said reaction point is slidable.

104. The portable torque verification system as recited in claim 103, further comprising:
a means for rotating said second transducer.

105. The portable torque verification system as recited in claim 102, further comprising:
a means for rotating said second transducer.

106. The portable torque verification system as recited in claim 101, wherein:
said reaction point is slidable.

107. The portable torque verification system as recited in claim 106, further comprising:
a means for rotating said second transducer.

108. The portable torque verification system as recited in claim 101, further comprising:
a means for rotating said second transducer.

109. A portable torque verification system, which comprises:
a rigid base plate;
a first torque sensor attached to said rigid base plate;
a support vertically fixedly mounted to said rigid base plate;
a second torque sensor supported by said support; and
a reaction point attached to said rigid base plate.

110. The portable torque verification system as recited in claim 109, wherein:
said reaction point is removable.

111. The portable torque verification system as recited in claim 110, wherein:
said reaction point is slidable.

112. The portable torque verification system as recited in claim 111, further comprising:
a means for rotating said support.

113. The portable torque verification system as recited in claim 110, further comprising:
a means for rotating said support.

114. The portable torque verification system as recited in claim 109, wherein:
said reaction point is slidable.

115. The portable torque verification system as recited in claim 114, further comprising:
a means for rotating said support.

116. The portable torque verification system as recited in claim 109, further comprising:
a means for rotating said support.

117. The portable torque verification system as recited in claim 109, further comprising:
an auxiliary support attached to said rigid base plate, said auxiliary support having a fixed height.

118. The portable torque verification system as recited in claim 117, wherein:
said reaction point is removable.

119. The portable torque verification system as recited in claim 118, wherein:
said reaction point is slidable.

120. The portable torque verification system as recited in claim 119, further comprising:
a means for rotating said support.

121. The portable torque verification system as recited in claim 118, further comprising:
a means for rotating said support.

122. The portable torque verification system as recited in claim 117, wherein:
said reaction point is slidable.

123. The portable torque verification system as recited in claim 122, further comprising:
a means for rotating said support.

124. The portable torque verification system as recited in claim 117, further comprising:
a means for rotating said support.

125. The portable torque verification system as recited in claim 109, further comprising:
an auxiliary support attached to said rigid base plate, said auxiliary support having a lockably variable height.

126. The portable torque verification system as recited in claim 125, wherein:
said reaction point is removable.

127. The portable torque verification system as recited in claim 126, wherein:
said reaction point is slidable.

128. The portable torque verification system as recited in claim 127, further comprising:
a means for rotating said support.

129. The portable torque verification system as recited in claim 126, further comprising:
a means for rotating said support.

130. The portable torque verification system as recited in claim 125, wherein:
said reaction point is slidable.

131. The portable torque verification system as recited in claim 130, further comprising:
a means for rotating said second transducer.

132. The portable torque verification system as recited in claim 125, further comprising:
a means for rotating said support.

133. A portable torque verification system, which comprises:
a rigid base plate;
a first torque sensor attached to said rigid base plate;
a support having a lockably adjustable height mounted to said rigid base plate;
a second torque sensor supported by said support; and
a reaction point attached to said rigid base plate.

134. The portable torque verification system as recited in claim 133, wherein:
said reaction point is removable.

135. The portable torque verification system as recited in claim 134, wherein:
said reaction point is slidable.

136. The portable torque verification system as recited in claim 135, further comprising:
a means for rotating said support.

137. The portable torque verification system as recited in claim 134, further comprising:
a means for rotating said support.

138. The portable torque verification system as recited in claim 133, wherein:
said reaction point is slidable.

139. The portable torque verification system as recited in claim 138, further comprising:
a means for rotating said support.

140. The portable torque verification system as recited in claim 133, further comprising:
a means for rotating said support.

141. The portable torque verification system as recited in claim 133, further comprising:
an auxiliary support attached to said rigid base plate, said auxiliary support having a fixed height.

142. The portable torque verification system as recited in claim 141, wherein:
said reaction point is removable.

143. The portable torque verification system as recited in claim 142, wherein:
said reaction point is slidable.

144. The portable torque verification system as recited in claim 143, further comprising:
a means for rotating said support.

145. The portable torque verification system as recited in claim 142, further comprising:
a means for rotating said support.

146. The portable torque verification system as recited in claim 141, wherein:
said reaction point is slidable.

147. The portable torque verification system as recited in claim 146, further comprising:
a means for rotating said support.

148. The portable torque verification system as recited in claim 141, further comprising:
a means for rotating said support.

149. The portable torque verification system as recited in claim 133, further comprising:
an auxiliary support attached to said rigid base plate, said auxiliary support having a lockably variable height.

150. The portable torque verification system as recited in claim 149, wherein:
said reaction point is removable.

151. The portable torque verification system as recited in claim 150, wherein:
said reaction point is slidable.

152. The portable torque verification system as recited in claim 151, further comprising:
a means for rotating said support.

153. The portable torque verification system as recited in claim 150, further comprising:
a means for rotating said support.

154. The portable torque verification system as recited in claim 149, wherein:
said reaction point is slidable.

155. The portable torque verification system as recited in claim 154, further comprising:
a means for rotating said support.

156. The portable torque verification system as recited in claim 149, further comprising:
a means for rotating said support.

157. A portable torque verification system, which comprises:
a rigid base plate;
a first torque sensor attached to said rigid base plate; and
a reaction point attached to said rigid base plate.

158. The portable torque verification system as recited in claim 157, wherein:
said reaction point is removable.

159. The portable torque verification system as recited in claim 158, wherein:
said reaction point is slidable.

160. The portable torque verification system as recited in claim 157, wherein:
said reaction point is slidable.
